(19) United States
(12) Patent Application Publication
(10) Pub. No.: US 2026/0159322 A1
(43) Pub. Date: Jun. 11, 2026

(54) LIFTING ASSEMBLY

(71) Applicant: OCADO INNOVATION LIMITED, Hatfield, Hertfordshire (GB)

(72) Inventors: Wilhelm Karl JOHANNISSON, Hatfield, Hertfordshire (GB); Malte GRUBER, Hatfield, Hertfordshire (GB)

(73) Assignee: OCADO INNOVATION LIMITED, Hatfield, Hertfordshire (GB)

(21) Appl. No.: 18/707,973

(22) PCT Filed: Nov. 9, 2022
(86) PCT No.: PCT/EP2022/081359

§ 371 Date: May 7, 2024

(30) Foreign Application Priority Data
Nov. 11, 2021 (GB) 2116253.2
Dec. 23, 2021 (GB) 2118977.4
Jan. 25, 2022 (GB) 2200960.9

(51) Int. Cl. B65G 1/06; B66C 19/00; B66D 1/20; B66D 1/74; B66D 1/76; B66F 9/065

(52) U.S. Cl. CPC B65G 1/065; B66C 19/00; B66D 1/20; B66D 1/7447; B66D 1/76; B66F 9/065; B66D 2700/0108; B66D 2700/015

(57) ABSTRACT

A container lifting assembly for raising and/or lowering containers stacked in stacks in a grid storage structure, includes a gripping device configured to releasably grip a container; and a raising and lowering mechanism configured to raise and lower the gripping device, with a gearing mechanism configured to wind and/or unwind at least one tether. A motor is configured to actuate the gearing mechanism to wind and/or unwind the at least one tether. The gearing mechanism includes a lifting pulley configured to pull the at least one tether up and/or lower the at least one tether down. A winding pulley is provided for spooling and/or unspooling the at least one tether; wherein the at least one tether extends from the winding pulley to the lifting pulley before extending and connecting to the gripping device.

### TECHNICAL FIELD

The present invention relates to the field of lifting assemblies. In particular, the present invention relates to lifting assemblies for load handling devices that lift and move storage containers.

### BACKGROUND

Some commercial and industrial activities require systems that enable the storage and retrieval of a large number of different products. WO2015/185628A describes a storage and fulfilment system in which stacks of storage containers are arranged within a grid storage structure. The containers are accessed from above by load handling devices operative on rails or tracks located on the top of the grid storage structure.

A given load handling device lifts a target container from the top of a stack, the target container usually containing inventory items needed to fulfil a customer order. The load handling device also lowers the target container back to the top of a stack, to the top of another stack or to another location, as required. The load handling devices typically comprise a lifting assembly for lifting the container from the first location and lowering the container to the second location. The load handling device must reliably lift and lower each container from the required locations.

It is against this background that the present invention has been devised.

### SUMMARY OF INVENTION

In a first aspect, there is provided a container lifting assembly for raising and/or lowering containers stacked in stacks in a grid storage structure, the lifting assembly comprising:
a gripping device configured to releasably grip a container;
a raising and lowering mechanism configured to raise and lower the gripping device the raising and lowering mechanism comprising:
   a gearing mechanism configured to wind and/or unwind at least one tether;
a motor configured to actuate the gearing mechanism to wind and/or unwind the at least one tether;
   wherein the gearing mechanism comprises:
a lifting pulley configured to pull the at least one tether up and/or lower the at least one tether down; and
a winding pulley for spooling and/or unspooling the at least one tether;
   wherein the at least one tether extends from the winding pulley to the lifting pulley before extending and connecting to the gripping device.

By providing a lifting pulley and a winding pulley for each tether, the lifting pulley can be used to pull the tether up, while the winding pulley can be used for winding (and/or unwinding) the tether, i.e. the tether only wind and unwinds from the winding pulley, it does not wind or unwind from the lifting pulley. By providing separate pulleys to perform the lifting and the winding (i. e the spooling) of the tether, the tether can wind and spool about the winding pulley in layers one on top of the other without causing tangling or knotting on the lifting pulley. Thus, the lifting assembly is able to significantly reduce or eliminate tangling of the tethers as they are wound and unwound to raise and lower the gripping device.

In another aspect, there is provided a container lifting assembly for raising and/or lowering containers stacked in stacks in a grid storage structure, the lifting assembly comprising:
a gripping device configured to releasably grip a container;
a raising and lowering mechanism configured to raise and lower the gripping device the raising and lowering mechanism comprising:
a gearing mechanism configured to wind and/or unwind at least one tether;
a motor configured to actuate the gearing mechanism to wind and/or unwind the at least one tether;
   the gearing mechanism comprises a lifting pulley configured to pull the at least one tether up and/or lower the at least one tether down;
   wherein the lifting assembly comprises a collecting holder for collecting the at least one tether being wound to lift the gripping device.

In another aspect, there is provided a load handling device for lifting and moving containers stacked in stacks in a grid storage structure comprising a plurality of tracks arranged in a grid pattern above the stacks of containers, the load handling device comprising:
a body housing a driving mechanism operatively arranged for moving the load handling device on the grid;
a container lifting assembly as described above, configured to raise and lower the gripping device relative to the body and for raising and lowering containers stacked in stacks.

The lifting assembly may be located within the body of the load handling device (e.g. within an upper portion of the body). The lifting assembly may raise a container into the body (e.g. into a cavity of the load handling device).

In another aspect, there is provided a load handling device for lifting and moving containers stacked in stacks in a grid storage structure comprising:
a first set of parallel tracks and a second set of parallel tracks extending substantially perpendicularly to the first set of tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces; the load handling device comprising:
a body mounted on a first set of wheels being arranged to engage with the first set of parallel racks and a second set of wheels being arranged to engage with the second set of parallel tracks, the body housing a drive mechanism configured to drive the load handling device on the grid;
a container lifting assembly as described above, configured to raise and lower the gripping device relative to the body and for raising and lowering containers stacked in stacks.

In another aspect, there is provided a method of raising and/or lowering a container from a stack of containers, the method comprising the load handling device as described above, the method comprising the steps of:
actuating the gearing mechanism so as to unwind the at least one tether and lower the gripping device relative to the body
actuating the gripping device to grip a container
actuating the gearing mechanism so as to wind the tethers and raise the gripping device relative to the body.

The method may comprise the step of raising the gripping device relative to the body and lifting the container into a cavity of the load handling device.

In another aspect, there is provided a system comprising:
a load-handling device as defined above;
a storage structure for accommodating containers stacked in stacks, the storage structure including a first set of tracks extending in a first direction and a second set of tracks extending in a second direction transverse to the first direction, the load-handling device configured to move on the first and second sets of tracks,
a control utility configured to control the load handling device to lift a container from a stack beneath the grid and/or lower a container into the grid.

In any one of the above aspects, the tether(s) may be in the form of cables, ropes, tapes or any other form of tether with the necessary physical properties to lift the containers. The tethers may be formed of or comprise polyester material (e.g. woven polyester material). In particular, the tethers may comprise woven polyester tapes or belts, e.g. seat belts (i.e. seat belts may be used as the tethers). The tethers may comprise dyneema tape. The tethers may comprise polyester material (e.g. woven polyester) combined with dyneema tape. The tethers may comprise cotton material. The tethers may comprise webbing material, e.g. webbed polyester, nylon, cotton. The tethers may comprise conductive material, for example the tethers may comprise woven material or woven polyester material with a conductive element or wiring (e.g. copper) woven into the weave or fabric of the tethers. The tethers may comprise woven belts (e.g. seat belts) with a conductive element or wiring woven into the belt. The tethers may comprise a conductive element or wiring (e.g. copper) woven into the weave or fabric of the tethers so as to provide power and/or communication (i.e. electrical communication) to the gripping device, or between the load handling device (e.g. a power source or a communication source provided in the body of the load handling device) and the gripping device.

### BRIEF DESCRIPTION OF THE DRAWINGS

Aspects and example embodiments of the present invention will now be described with reference to the accompanying drawings.

FIG. 1 is a schematic perspective view of a grid storage structure and containers;

FIG. 2 is a schematic top view of a track on top of the storage structure of FIG. 1;

FIG. 3 shows load handling devices on top of the storage structure of FIG. 1;

FIG. 4 is a schematic perspective view of a load handling device with a lifting assembly in a lowered configuration;

FIG. 5 shows schematic cutaway views of the load handling device of FIG. 4 with the lifting assembly in a raised and a lowered configuration;

FIGS. 6A, 6B and 6C are perspective views of the load handling device with a gripping device being lowered onto a container;

FIG. 7 is a perspective view of an embodiment of lifting assembly assembled in a load handling device;

FIG. 8 is a perspective view of the lifting assembly of FIG. 7;

FIG. 9 is a perspective view of another embodiment of lifting assembly;

FIG. 10 is a cross-section view of a winding pulley;

FIG. 11 is a perspective view of another embodiment of lifting assembly;

FIG. 12 is a perspective view of another embodiment of lifting assembly;

FIG. 13 is a detailed view of the lifting assembly of FIG. 12;

FIG. 14 is a perspective view of another embodiment of lifting assembly;

FIG. 15 is a perspective view of another embodiment of lifting assembly;

FIG. 16 is a detailed view of the lifting assembly of FIG. 15; and

FIG. 17 is a perspective view of another embodiment of lifting assembly.

### DETAILED DESCRIPTION

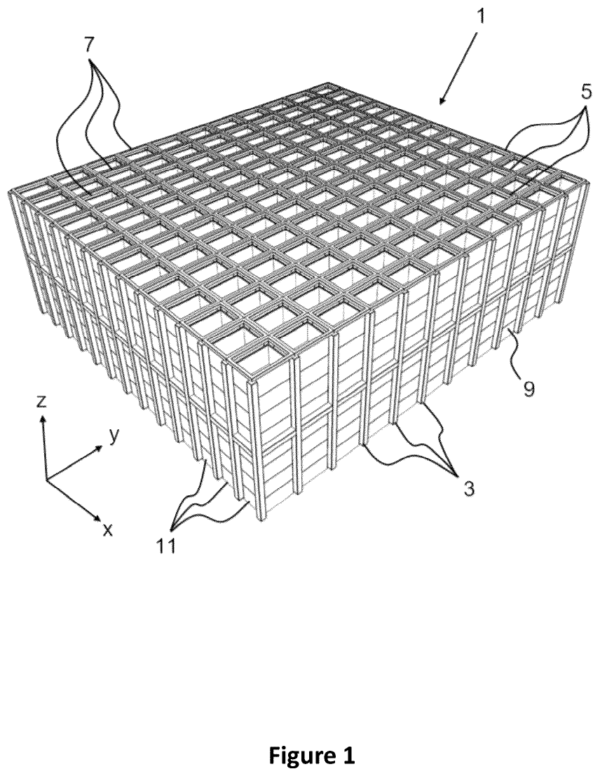

FIG. 1 illustrates a storage structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, storage containers 9 are arranged in stacks 11 beneath the grid cells defined by the grid pattern, one stack 11 of containers 9 per grid cell.

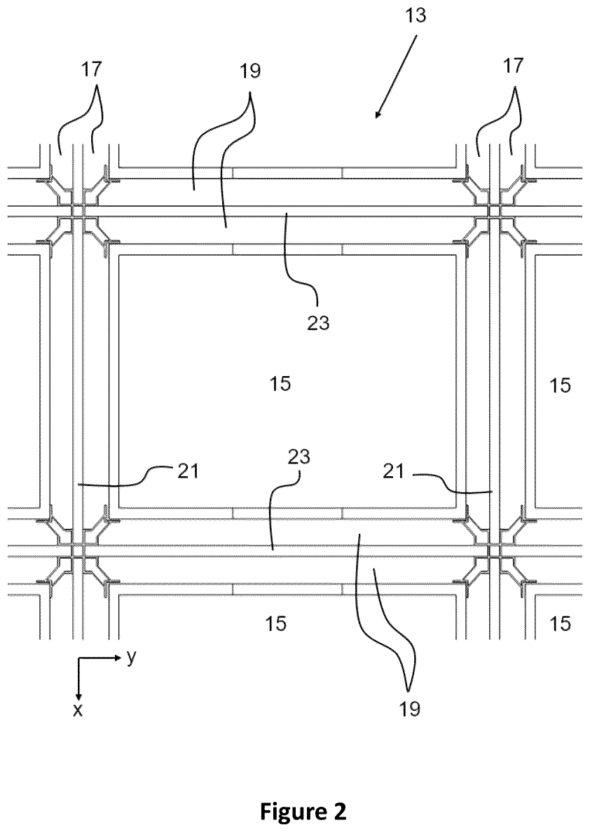

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

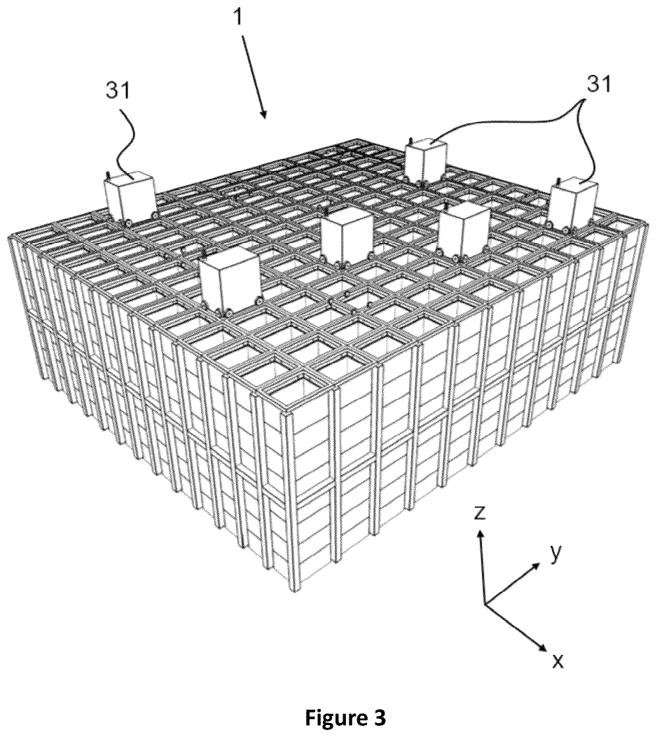

FIG. 3 shows a plurality of load handling devices 31 moving on top of the storage structure 1 illustrated in FIG. 1. The load handling devices 31, which may also be referred to as robots or bots, are provided with sets of wheels to engage with corresponding x-or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

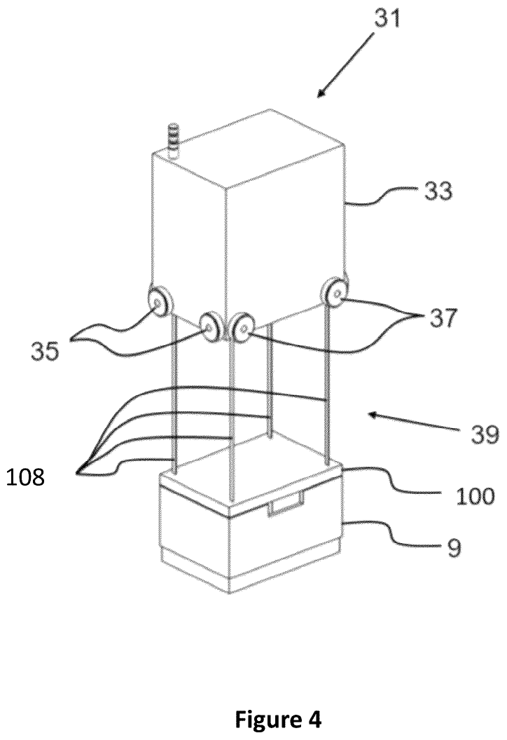

As illustrated in FIG. 4, the bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x-and y-directions along the tracks 17 and 19, respectively. In particular, two wheels 35 are provided on the shorter side of the bot 31 visible in FIG. 4, and a further two wheels 35 are provided on the opposite shorter side of the bot 31 (not visible in FIG. 4). The wheels 35 engage with the tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (not visible in FIG. 4). The wheels 37 engage with the tracks 19 and are rotatably mounted on the body 33 of the bot 31 to allow the bot 31 to move along the tracks 19.

The bot 31 also comprises a lifting assembly 102 comprising a raising and lowering mechanism 39 configured to raise and lower containers 9. The illustrated raising and lowering mechanism 39 comprises four tethers 108 which are connected at their lower ends to a gripping device 100. The tethers 108 may be in the form of cables, ropes, tapes, or any other form of tether with the necessary physical properties to lift the containers 9. The gripping device 100 comprises at least one gripper configured to engage with features of the containers 9. For example, the containers 9 may be provided with one or more apertures in their upper sides with which the gripper can engage. Alternatively or additionally, the gripper may be configured to hook under the rims or lips of the containers 9, and/or to clamp or grasp the containers 9. The tethers 108 may be wound up or down to raise or lower the gripping device 100, as required. One or more motors 110 or other means may be provided to effect or control the winding up or down of the tethers 108.

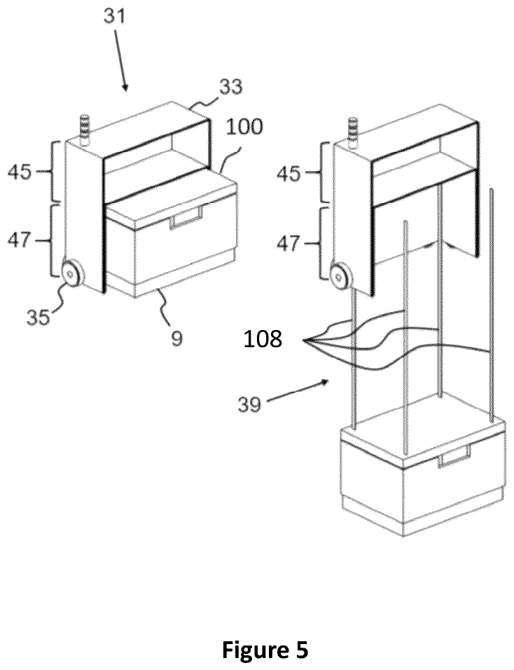

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lifting assembly 102 is in an upper part of the lower portion. However, in other embodiments, it may be in the upper portion 45. The lower portion 47 comprises a container-receiving space or cavity for accommodating at least part of a container 9 that has been raised by a lifting assembly 102 that comprises the raising and lowering mechanism 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the lifting assembly 102 controls the tethers 108 to lower the gripping device 100 and the corresponding container 9 out of the cavity and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

The container-receiving space of the bot 31 may not be within the body 33 of the bot 31. For example, the container-receiving space may instead be adjacent to the body 33 of the bot 31, e.g. in a cantilever arrangement with the weight of the body 33 of the bot 31 counterbalancing the weight of the container to be lifted. In such embodiments, a frame or arms of the raising and lowering mechanism 39 may protrude horizontally from the body 33 of the bot 31, and the tethers 108 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by the wheel-positioning mechanism.

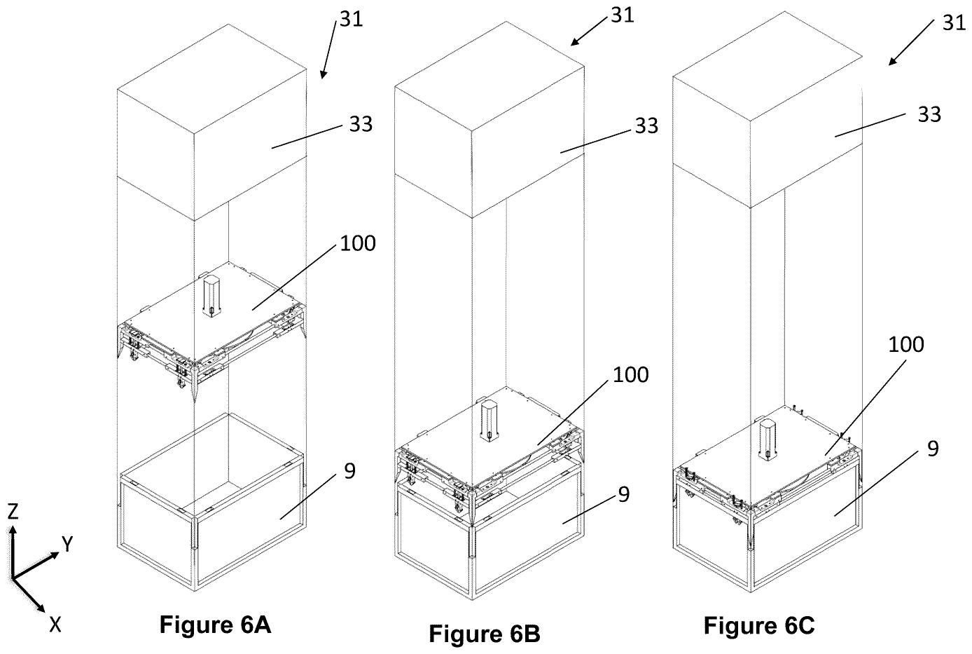

FIGS. 6A, 6B and 6C show perspective views of the load handling device 31 with an embodiment of gripping device 100 suspended from the load handling device 31, in particular from the load handling device body 33. Although not shown in these figures, the load handling device 31 includes the features described above in relation to the load handling device or bot 31, including the first and second sets of wheels 35, 37 mounted to the body of the load handling device 31, the cavity for receiving at least part of the container and the reeled tethers 108 connected at their lower ends to the gripping device 100 for connecting and suspending the gripping device 100 from the load handling device 31. The land handling device 31 comprises the lifting assembly 102 which winds or unwinds the reeled tethers 108 the tethers 108 being wound and unwound respectively to raise and lower the gripping device 100 as shown in FIGS. 6A, 6B and 6C. The gripping device 100 is lowered onto a container to be lifted, until it contacts with an upper rim of the container 9. Once the gripping device 100 is into position on the container 9 as shown in FIG. 6C, the gripping device 100 engages and grips the container.

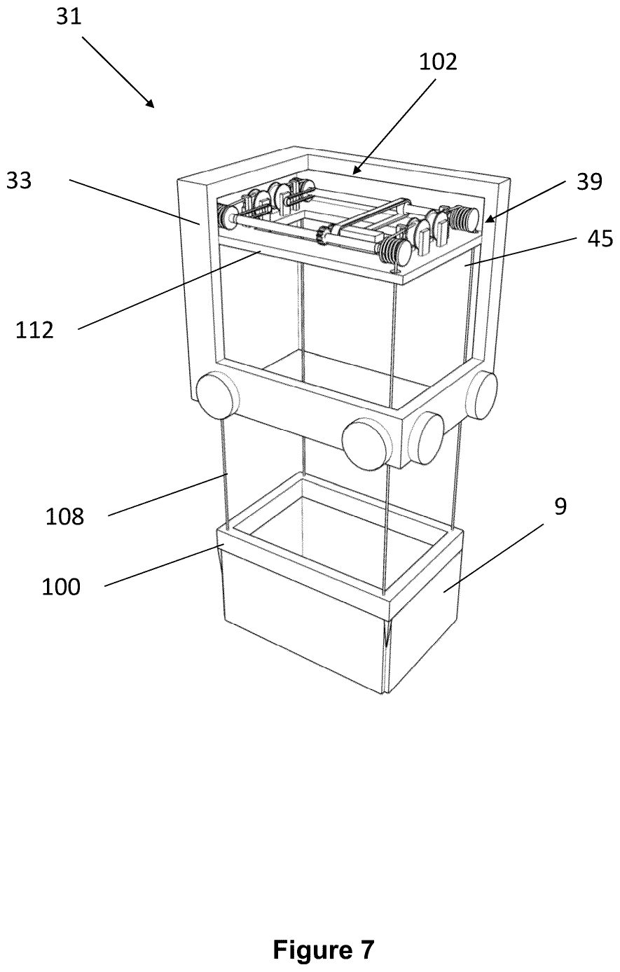

FIG. 7 shows an embodiment of lifting assembly 102 provided in the upper portion 45 of the body 33 of the load handling device 31. As shown in FIG. 7, the lifting assembly 102 comprises a raising and lowering mechanism 39 including a gearing mechanism 104, four pulleys 106 and four tethers 108 extending downwards from the gearing mechanism 104 such that a lower end of each tether 108 connects to the gripping device 100. The raising and lowering mechanism 39 includes a motor 110 configured to rotate the gearing mechanism 104 so as to wind and unwind the tethers 108 about the pulleys 106 thereby lifting or lowering the gripping device 100. The gripping device 100 is configured to grip onto a container 9 such that winding of the tethers lifts the gripping device 100 thereby allowing the load handling device 31 to lift the container into the body 33 of the load handling device 31. Unwinding of the tethers 108 lowers the gripping device 100 thereby allowing the load handling device 31 to lower the container into a required position (e.g. on top of another stack of containers in the storage structure). The lifting assembly 102 includes a substantially rectangular support frame 112 for supporting the motor 110 and the raising and lowering mechanism 39 (including the gearing mechanism). The tethers 108 extend down from the gearing mechanism and connect to the gripping device 100 so as to lift or lower the gripping device 100.

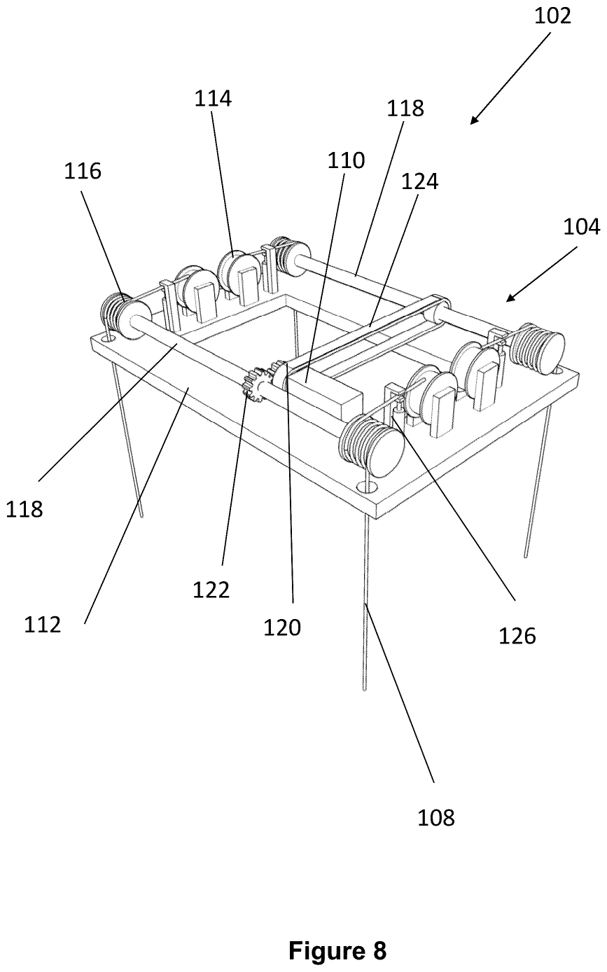

FIG. 8 shows a perspective view of the lifting assembly 102 of FIG. 7. The lifting assembly 102 comprises four winding pulleys 114 and four lifting pulleys, which in this embodiment comprise capstan pulleys 116, the capstan pulleys 116 being provided at each corner of the lifting assembly 102, in particular at each corner of the support frame 112. Each winding pulley 114 comprises a tether 108 which winds or unwinds from the winding pulley 114 as the gripping device 100 is lifted or lowered. Each tether 108 extends from its respective winding pulley 114 to a respective capstan pulley 116 before extending downwards to the gripping device 100 (not shown). The capstan pulleys 116 are provided at (or towards) the corners of the lifting assembly 102 such that the tethers 108 extend downwards and connect to the corners of the gripping device 100.

The tethers 108 wrap around the capstan pulley 116 a set number of times (e.g. one, two, three, four, five, six etc. times) before extending down to the gripping device 100.

By providing both a capstan pulley 116 and a winding pulley 114 for each tether 108, the capstan pulley 116 can be used to pull the tether up, while the winding pulley 114 can be used for winding (and unwinding) the tether i.e. the tether only winds and unwinds from the winding pulley 114, it does not wind or unwind from the capstan pulley 116. The number of turns or revolutions of each tether around each capstan pulley 116 remains the same as the tethers 108 are wound and unwound from the winding pulley 114. By providing separate pulleys to perform the lifting and the winding (i.e. spooling) of the tethers, the tethers can wind and spool about the winding pulley 114 in layers one on top of the other without causing tangling or knotting on the capstan pulley 116. Thus, the lifting assembly 102 is able to significantly reduce or eliminate tangling of the tethers as they are wound and unwound to raise and lower the gripping device 100. By providing capstan pulleys 116 to lift the tethers, the capstan pulleys 116 are advantageously able to pull the tethers up using friction alone (i.e. without requiring teeth on the pulleys to pull the tethers up). Furthermore, by providing capstan pulleys 116 to pull the tethers up, a relatively small holding force at the winding pulley 114 is required to carry a much larger loading force at the bottom of the tethers (i.e. the capstan pulleys 116 allow for relatively small winding pulleys 114 to pull up a relatively large load at the bottom of the tethers).

The capstan pulleys 116 are connected by drive shafts 118. In particular, the two capstan pulleys 116 at the first end of the raising and lowering mechanism 39 are connected to the two capstan pulleys 116 at the second end of the raising and lowering mechanism 39, opposite the first end, by a drive shaft such that each pair of connected capstan pulley 116 rotates in the same direction and at the same speed/rate. The raising and lowering mechanism 39 includes a motor 110 which drives the first drive shaft and second drive shafts. In particular, the motor 110 drives a first cog wheel 120 which in turn drives a second cog wheel 122 mounted to the first drive shaft such that the first drive shaft (and thus the capstan pulleys 116 connected by the first drive shaft) is driven (i. e rotated) by the motor 110. The raising and lowering mechanism 39 includes a timing belt 124 which connects the first cog wheel to the second drive shaft so that the motor 110 can drive the second drive shaft. In particular, the timing belt ensures that the first and second drive shafts rotate at the same speed (from the output of the motor 110). The ratio of the cog wheels is chosen to provide a suitable rotation speed from the output of the motor 110 to rotation of the drive shafts (and as such of the capstan pulleys 116). The cog wheels are also configured to reverse the rotation of the drive shafts from the output of the motor 110.

The size (i.e. the diameter) of the winding pulley 114 and the capstan pulley 116 can be chosen to affect and control the relative rotation of the winding pulley 114 relative to the capstan pulley 116 and vice versa. In other words, the diameter of the winding pulley 114 and the diameter of the capstan pulley 116 can be different so as to affect the speed at which the winding pulley 114 rotates relative to the capstan pulley 116. In this way, the rate at which the winding pulley 114 rotates relative to the capstan pulley 116 (and thus the timing belt) can be controlled (and vice versa). In some embodiments, the capstan pulley 116 has a diameter half the size of the diameter of the winding pulley 114, such that the winding pulley 114 rotates at half the speed of the capstan pulley 116. The diameter of the capstan pulley 116 determines the torque and speed of the motor 110. Thus, in some embodiments, it is desirable to have a relatively small diameter capstan pulley 116 (e.g. half the size of the diameter of the winding pulley 114) such that a motor 110 with small torque can be provided. In some embodiments, it may be desirable to have a relatively large diameter winding pulley 114 (e.g. double the size of the diameter of the capstan pulley 116) such that a smaller number of rotations of the winding pulley 114 is required to wind up the length of the tether 108.

Each winding pulley 114 comprises a spring loaded spooling mechanism (e.g. a spring) which biases the winding pulleys 114 towards the winding direction. In this way, the winding spools are self-driven or auto-spooling by the spring and do not require a motor 110 to drive them.

The lifting assembly 102 comprises four actuators or pinchers 126 located between each capstan pulley 116 and winding pulley 114 and configured to pinch the tethers 108 and remove the tension in the tethers 108. By removing the tension in the tethers, the capstan pulleys 116 can be driven to rotate without lifting the tethers (i.e. the capstan pulleys 116 are configured to spin between the tethers without pulling the tethers upwards). A particular pincher can be actuated to pinch a particular tether 108 while the capstan pulleys 116 are rotated, preventing the pinched tether from being wound up as the other (non-pinched) tethers are wound upwards. This allows the lifting assembly 102 to level an uneven gripping device 100, even while it carries a load or a container. Any one or more of the pinchers can be actuated to pinch the tethers to remove the tension in those tethers and the capstan pulleys 116 rotated to level an uneven gripping device 100 as required. Each pincher is driven by an actuator (e.g. a linear actuator) which is controlled to actuate the pinchers as required. The actuators can be controlled individually so as to pinch the required tethers.

In some embodiments, the lifting pulleys are mounted to the drive shafts 118 via a slip clutch. By providing a slip clutch for each pulley, the lifting assembly can level the gripping device should the gripping device become uneven (e.g. during lowering and/or lifting of the gripping device or due to stretching or slipping of one or more of the tethers). The first and/or second drive shafts are rotated by the motor to wind the tethers and lift the gripping device. Once the gripping device reaches its top or fully lifted position (i.e. the gripping device 100 is fully lifted by the raising and lowering mechanism 39 e.g. into the body 33 of the bot 31), the motor can over drive beyond the torque of the slip clutches such that the slip clutches slip and the spools no longer rotate. Each lifting pulley comprises a hard stop (e.g. a mechanical stop) against which the gripping device abuts once it reaches its fully lifted position. In the event that the gripping device becomes uneven, e.g. one side of the gripping device may be higher than the other side, or one or more corners of the gripping device may be higher than the remaining corners of the gripping device, the higher side or corner(s) will reach their fully lifted positions and abut against the hard stops before the uneven lower side or corner(s) of the gripping device reach the hard stops. To level the uneven gripping device, the motor can over rotate the drive shafts so as to bring up the uneven lower side or corner(s) of the gripping device. During this over driving or over rotation of the motor, the slip clutches at the side or corner(s) already at the fully lifted position will slip and prevent further rotation of those pulleys, thereby keeping the side or corner(s) already at the fully lifted position abutted against the hard stops. In this way, the motor over elevates the gripping device against the hard stops each time the gripping device is raised. The slip clutches allow the motor to over rotate the drive shafts and bring up any uneven lower side or corner(s) of the gripping device, while keeping any side or corner(s) of the gripping device already at the fully lifted position abutted against the hard stops. In this way, the lifting assembly can calibrate and level the gripping device each time the gripping device is raised.

The slip clutches are centrally located on each pulley and include a shaft or hollow bore which is mounted to the lifting shaft, thereby mounting the spool to the lifting shaft. The slip clutch may be a spring clutch or an electromagnetic clutch (e.g. a permanent magnet clutch or a hysteresis/magnetic particle clutch). The slip clutch may be a fixed torque or an adjustable torque clutch.

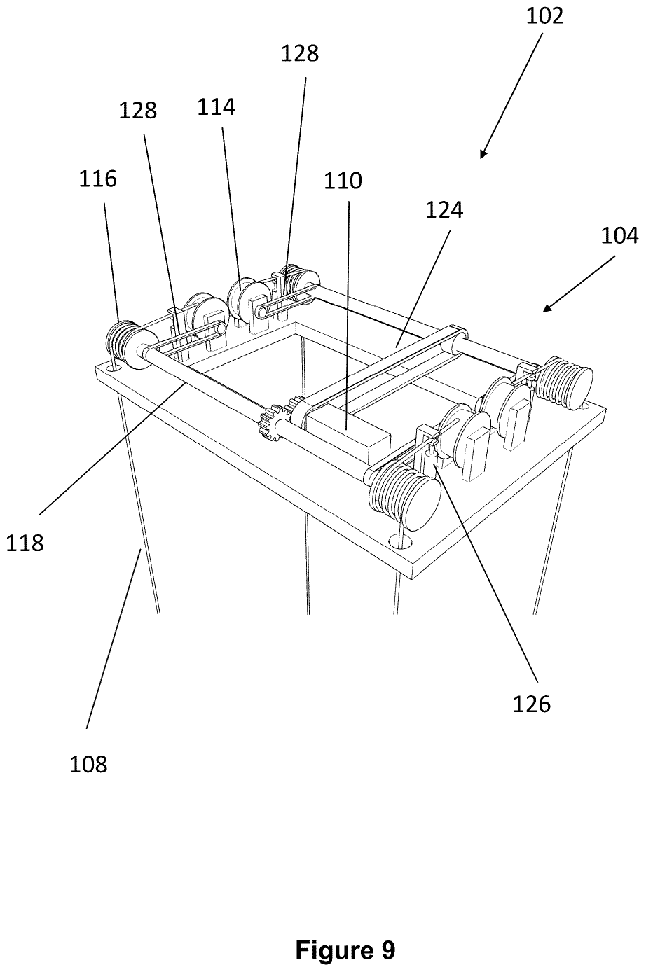

FIG. 9 shows another embodiment of lifting assembly 102 which comprises all the features described in relation to the embodiment of FIG. 8, including an additional timing belt 128 for each winding pulley 114 and connecting each winding pulley 114 to one of the drive shafts. A first winding pulley 114 at the first end of the raising and lowering mechanism 39 and a first winding pulley 114 at the second end of the raising and lowering mechanism 39 are each connected via a timing belt to the first drive shaft. A second winding pulley 114 at the first end of the raising and lowering mechanism 39 and a second winding pulley 114 at the second end of the raising and lowering mechanism 39 are each connected via a timing belt to the second drive shaft. These timing belts 128 connecting the winding pulleys 114 to the drive shafts are in addition to the main timing belt 124 (described above in relation to FIG. 8) connecting the motor 110 to the second drive shaft. These additional timing belts 128 connecting the winding pulleys 114 to the drive shafts ensure the winding pulleys 114 rotate at the same time and speed as the drive shafts, and thus the capstan pulleys 116. By ensuring the winding pulleys 114 rotate at the same time and speed as the capstan pulleys 116, the appropriate and optimal tension is maintained on the tethers 108 allowing the capstan pulleys 116 to function as required.

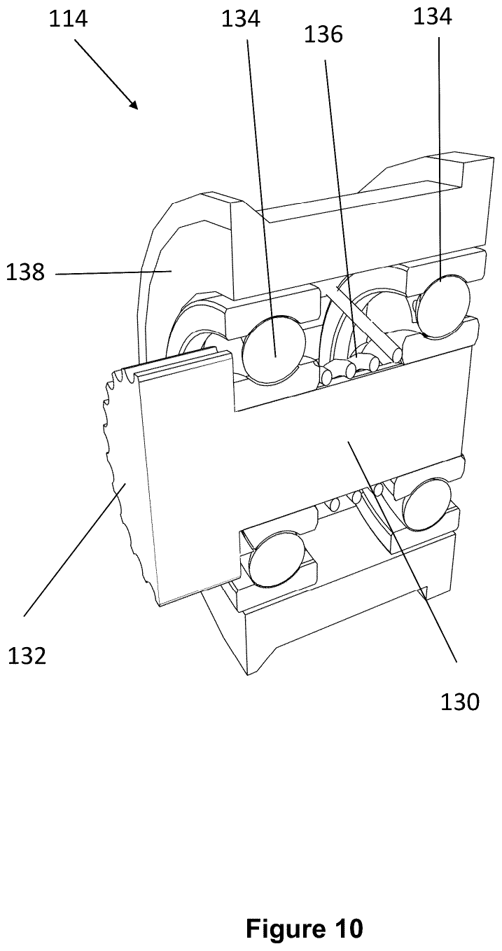

FIG. 10 shows a cross-section detailed view of one of the winding pulleys 114 of the embodiment of FIG. 9. The winding pulley 114 comprises an inner pin 130 which extends axially through the centre of the winding pulley 114 and includes a toothed gear 132 at one end of the pin and extending out from the winding pulley 114. The gear receives one end of the timing belt 128 connecting the winding pulley 114 to the drive shaft, as described above, such that the pin rotates at the same speed as the drive shaft and thus the capstan pulley 116 connected to the drive shaft. Surrounding the pin are two ball bearings 134 and a spring 136 located between the two ball bearings. Surrounding the ball bearings and the spring is an outer ring 138 on which the tether 108 is wound. The ball bearings allow the outer ring 138 to rotate freely in relation to the inner pin.

As the inner pin rotates with the capstan pulley 116, the outer ring 138 rotates to wind and/or unwind the tether 108. The ball bearings allow the outer ring 138 to rotate freely relative to the inner pin so as to account for any difference in spin between the inner pin and the outer ring 138, as described further below. As the tether 108 spools onto the outer ring 138, the overall diameter of the wound tether 108 about the winding pulley 114 increases. Without the provision of the spring with the ball bearings and the outer ring 138, the winding pulley 114 would rotate at the same speed as the inner pin, and thus the capstan pulley 116. This can result in the tension on the tether between the capstan pulley 116 and the winding pulley 114 to increase as the tether is wound on the winding pulley 114. The optimal tension on the tether as the tether is wound on the winding pulley 114 may only be reached at a particular diameter of the wound tether. At the start of winding, when the diameter of the wound tether is smaller, the tension on the tether is less than the optimal required tension, resulting in the tether becoming slack. Towards the end of winding, when the diameter of the wound tether is larger, the tension on the tether may be greater than the optimal required tension, affecting the efficiency and performance of the capstan pulley 116. Alternatively, in some embodiments, the tension on the tether between the capstan pulley 116 and the winding pulley 114 may decrease as the tether is wound on the winding pulley 114.

To ensure the optimal required tension is applied to the tether 108 as the tether 108 is wound onto the winding pulley 114, the spring is configured to bias the outer ring 138 so as to take up any slack in the tether 108 as the winding pulley 114 rotates to wind the tether, thus maintaining the optimal tension in the tether. The ball bearings allow the outer ring 138 to rotate freely relative to the inner pin, thereby accounting for any difference in spin of the outer ring 138 compared to the inner pin as the winding pulley 114 rotates. The spring may be a torsional spring or a spiral spring. Thus, the winding pulleys 114 are able to take up any slack in the tether as the winding pulleys 114 rotate to wind the tethers as well as account for any difference in spin of the outer ring 138 compared to the inner pin. The winding pulleys 114 may therefore be referred to as differential spools.

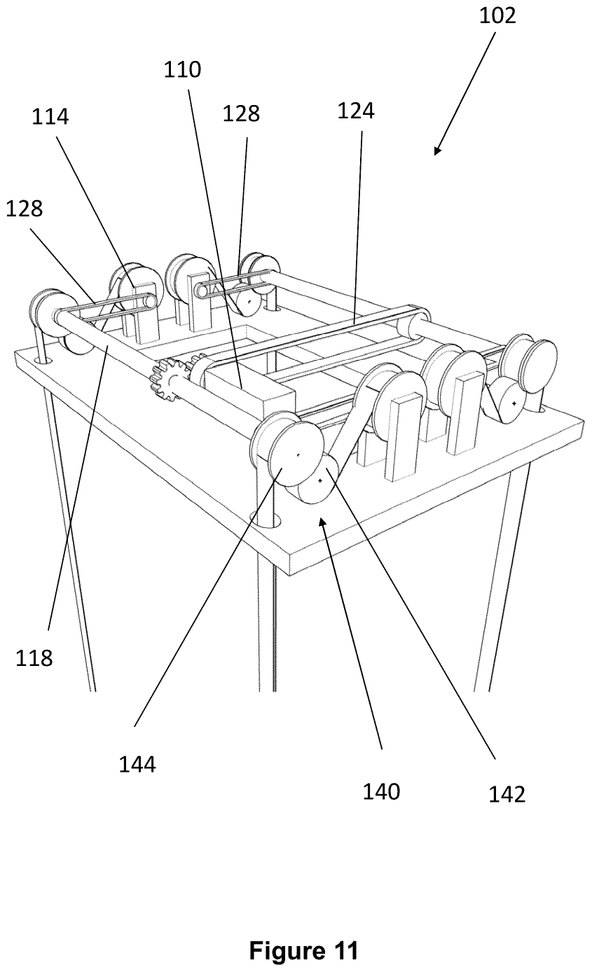

FIG. 11 shows another embodiment of lifting assembly 102 comprising four pulley assemblies 140, one at each corner of the lifting assembly 102 for pulling the tethers 108 up, and four winding pulleys 114 for winding and/or unwinding the tethers 108 as described above. Each tether 108 is wound about and/or unwound from a winding pulley 114 and extends from the winding pulley 114 to wrap around a first connecting pulley 142 of the pulley assembly 140 before wrapping around a second lifting pulley 144 of the pulley assembly 140. Each tether 108 wraps under the connecting pulley 142 before wrapping over the lifting pulley 144 and then extending downwards to connect to the gripping device. Each pair of opposing lifting pulley 144 is connected by a drive shaft which is driven to rotate the lifting pulleys 144 and pull the tethers up. The two drive shafts are driven by a motor 110 and a timing belt as described above in relation to the embodiments of FIGS. 8 and 9. In this embodiment, as with the embodiments of FIGS. 8 and 9, separate pulley systems are provided to pull the tethers up and wind the tethers, i.e. the winding pulleys 114 are used for winding (and unwinding) the tethers while the pulley assemblies 140 are used to pull the tethers up. By providing a separate pulley system to perform the lifting and the winding of the tethers, the tethers can wind and spool about the winding pulley 114 in layers one on top of the other without causing tangling on the pulley assemblies 140, thereby significantly reducing or eliminating tangling of the tethers as they are wound and unwound to raise and lower the gripping device 100. The pulley assemblies 140 allow the lifting assembly 102 of this embodiment to use tethers such as tape which, in some circumstances, may be preferable over rope as tape is often stronger and lighter than rope and spools in a more orderly fashion than rope. The lifting assembly 102 includes a spring which biases or pushes the connecting pulley 142 and the lifting pulley 144 towards each other. The spring is configured to provide a clamping force between the pulleys of the pulley assembly 140 so as to prevent the tether 108 from slipping and/or becoming loose between the pulleys. The connecting pulley 142 and the lifting pulley 144, as well as the winding pulley 114 are formed of rubber so as to increase the friction between the tether 108 and the pulleys and further prevent slipping of the tether 108 between the pulleys. The embodiment of FIG. 11 may also include the additional timing belts 128 and the differential spools described above.

In some embodiments, the lifting pulleys are mounted to the drive shafts via slip clutches. By providing a slip clutch for each lifting pulley, the lifting assembly can level the gripping device should the gripping device become uneven as described above in relation to FIG. 8.

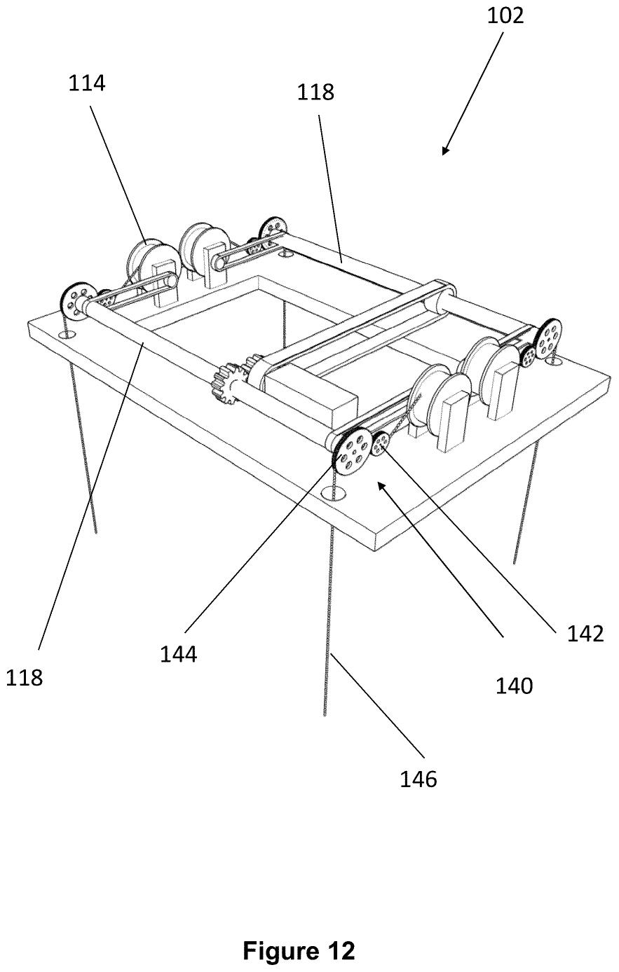

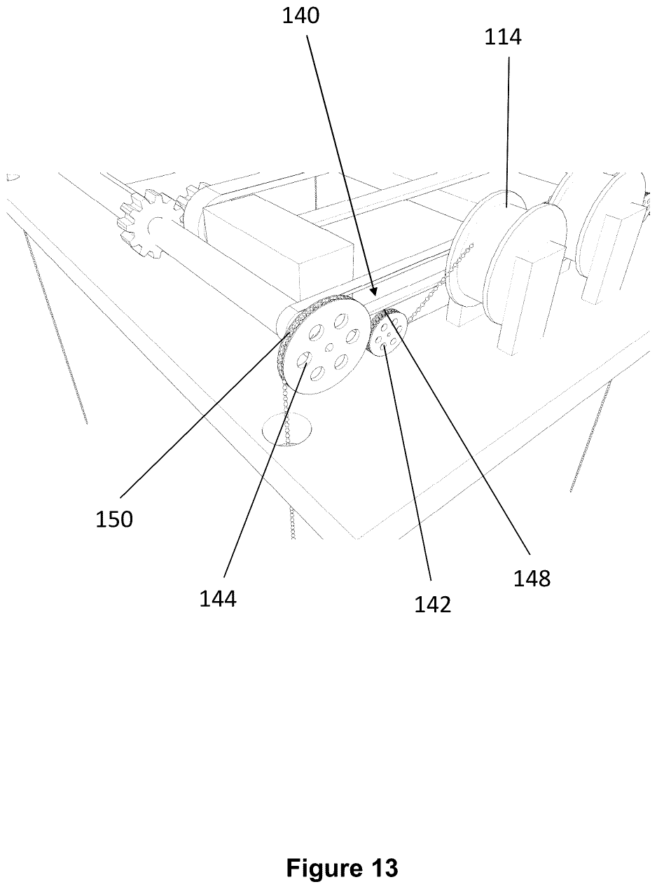

FIG. 12 shows another embodiment of lifting assembly 102 which comprises four tethers in the form of ball chains tethers 146. Each ball chain tether 146 extends from a winding pulley 114 to a pulley assembly 140 where the tether 146 wraps under a connecting pulley 142 before wrapping over a lifting pulley 144 as described above in relation to the embodiment of FIG. 11. The lifting assembly 102 comprises two drive shafts, for connecting the pairs of opposing lifting pulleys 144, the drive shafts being driven by a motor 110 and a timing belt to rotate the lifting pulleys 144. FIG. 13 shows a detailed view of the pulley assembly 140 of the embodiment of FIG. 12. As shown by FIG. 13, the ball chain tether 146 is received in a grooved channel 148 of the connecting pulley 142 and a grooved channel 150 of the lifting pulley 144, the grooved channels 148, 150 comprising circular or concave grooves sized to fit the balls of the ball chain tether 146. As the lifting pulley 144 is rotated to wind and/or unwind the tethers, the balls of the ball chain tethers 146 fit into the grooved channels providing discrete increments in rotation of the lifting pulleys 144. In this way, rotations of the lifting pulleys 144 can be accurately and precisely measured thereby also providing an accurate measurement of lifting and/or lowering of the gripping device 100. For example, based on a given number of rotations of the motor 110, the distance (up or down) travelled by the gripping device 100 can be accurately determined.

The ball chain tether 146 provides a timing based pulley where the timing is based on the geometry or shape of the balls in the ball chain. This is in contrast to the capstan pulleys 116 provided in the embodiments of FIGS. 8 and 9 where the holding force on the tethers is provided by friction of the tethers in the capstan pulleys 116. The balls in each of the ball chain tethers are of same size and evenly shaped so as to provide a synchronous drive as the tethers are wound and/or unwound to lift and/or lower the gripping device 100. By providing ball chain tethers, the lifting assembly 102 is able to significantly reduce or eliminate slipping of the ball chain tethers as they are wound and/or unwound.

In other embodiments, the tether may be a drive tape (e.g. a hole punched tape that cooperates with a connecting pulley 142 and a lifting pulley 144 comprising rounded protrusions that fit into the tape holes, e.g. a steel drive tape), a chain, a pipe chain, a roller chain, a timing belt etc. The tether may be any suitable tether that includes discrete geometric features that fit into cooperating geometric features in the connecting pulley 142 and the lifting pulley 144 such that the lifting pulley 144 can be rotated by discrete increments in rotation. The skilled person will know of a number of alternative tethers suitable for the embodiment of FIG. 12.

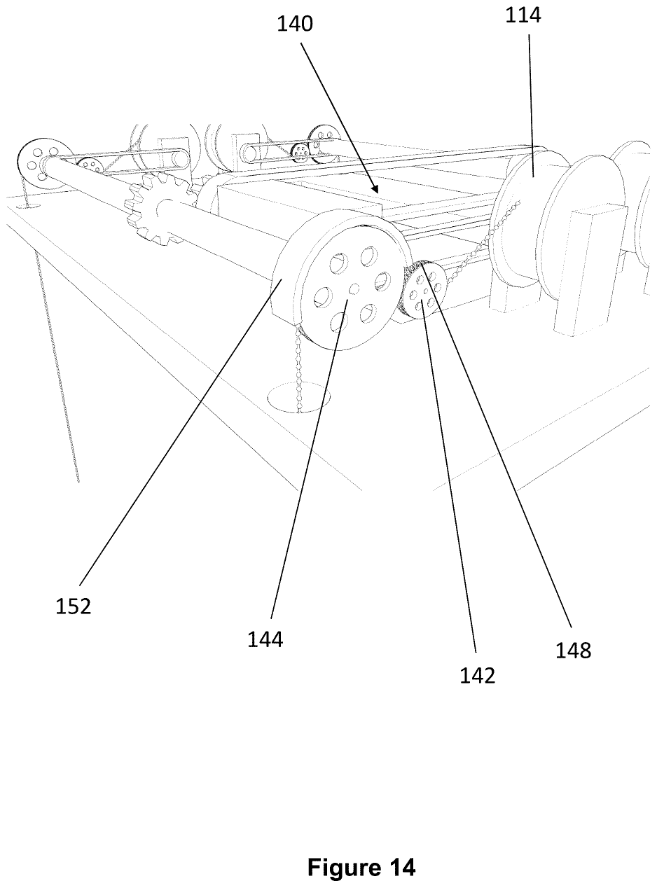

In some embodiments, the lifting pulleys 144 comprise a cover 152, as shown in FIG. 14, to secure the ball chain tether onto the lifting pulley 144 and prevent it from slipping or sliding off the lifting pulley 144. In other embodiments, the connecting pulleys 142 may also include a cover to secure the ball chain tether onto the connecting pulley 142 and prevent it from slipping or sliding off.

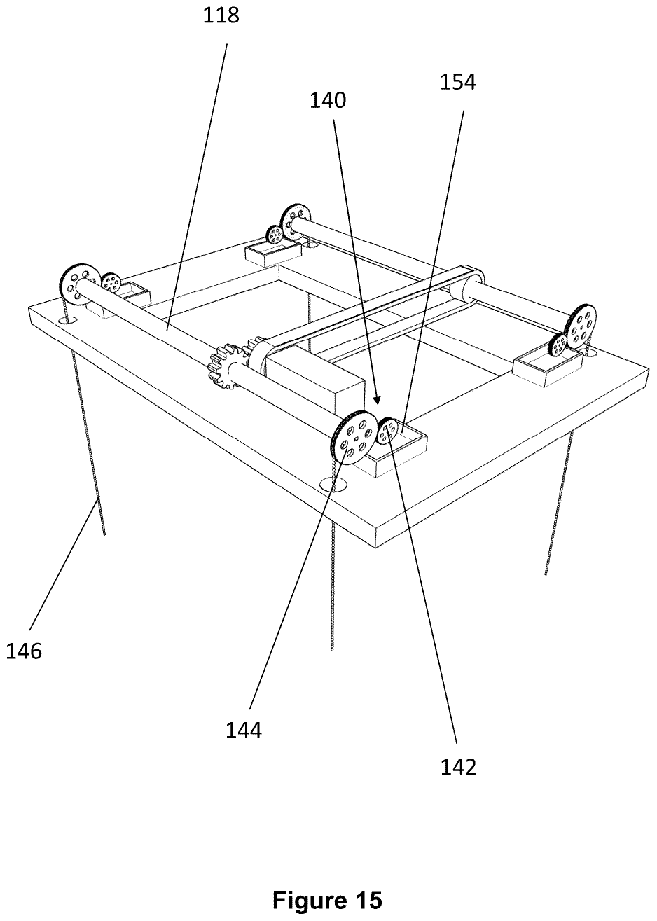

FIG. 15 shows another embodiment of lifting assembly 102 which comprises four ball chain tethers 146 and four pulley assemblies 140, one in each corner of the lifting assembly 102, as described above in relation to the embodiment of FIGS. 13 and 14. Each pulley assembly 140 comprises a lifting pulley 144 which is rotated to pull the tether up or down.

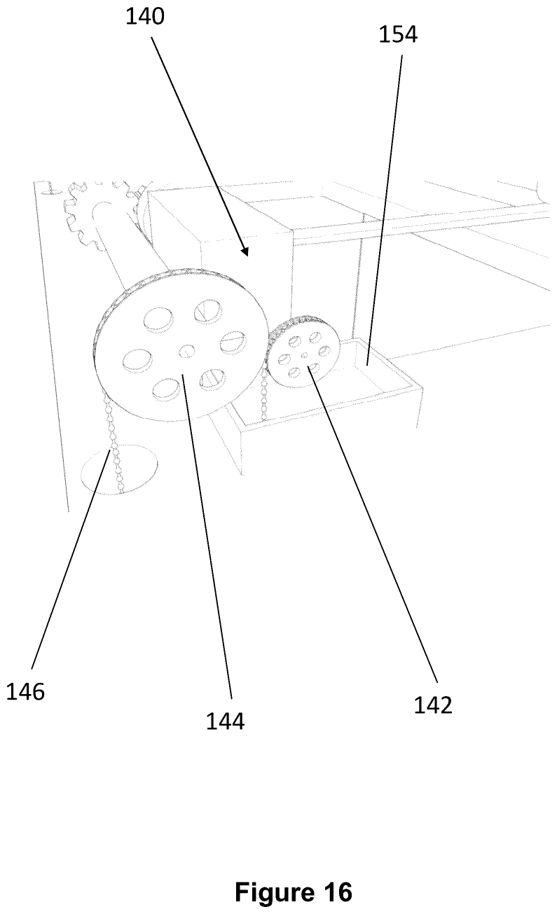

Each pair of opposing lifting pulley 144 is connected by a drive shaft which is driven to rotate the lifting pulleys 144 by a motor 110 and a drive belt. FIG. 16 shows a detailed view of the pulley assembly 140 of FIG. 15. Each pulley assembly 140 also comprises a connecting pulley 142 that is biased towards or clamped towards the lifting pulley 144 to secure the ball chain tether onto the lifting pulley 144 and prevent the ball chain tether 146 from becoming loose. The lifting assembly 102 comprises a collecting holder 154 under each lifting assembly 102, between the lifting pulley 144 and the connecting pulley 142, for collecting the tether 146 as it is wound to lift the gripping device 100. The ball chain tether 146 extends from the gripping device 100, over the lifting pulley 144, before extending back down between the lifting pulley 144 and the connecting pulley 142 and drops into the collecting holder 154. In this way, the tether does not spool about a winding pulley 114 as with the above embodiments, but instead is collected directly into the collecting holder 154. This provides a less complex lifting assembly 102 with less moving parts and a reduced risk of tangling of the tethers.

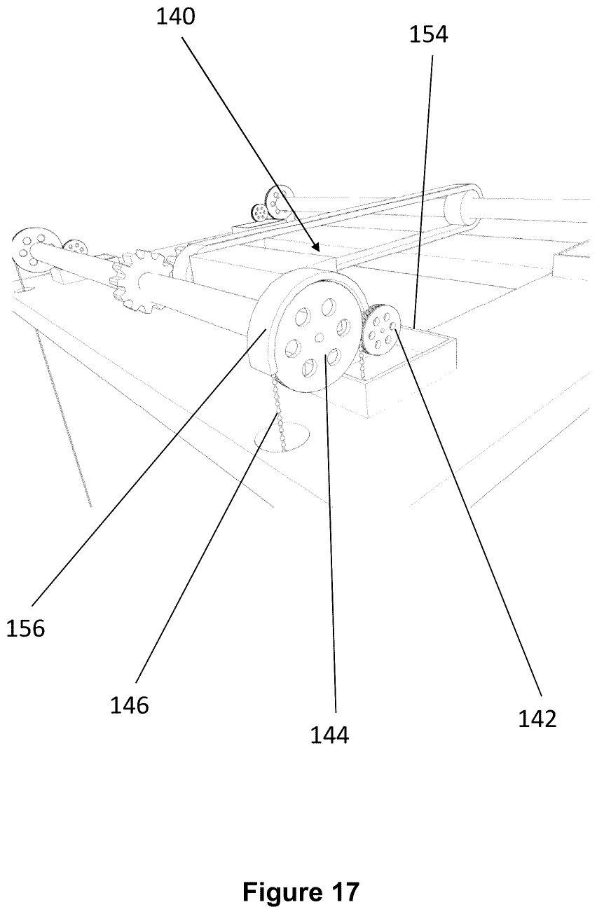

In some embodiments, the lifting pulleys 144 comprise a cover 156, as shown in FIG. 17, to secure the ball chain tether 146 onto the lifting pulley 144 and prevent it from slipping or sliding off the lifting pulley 144. In other embodiments, the connecting pulleys 142 may also include a cover to secure the ball chain tether onto the connecting pulley 142 and prevent it from slipping or sliding off.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

1-20-(canceled)

21. A container lifting assembly for raising and/or lowering containers stacked in stacks in a grid storage structure, the lifting assembly comprising:
a gripping device configured to releasably grip a container;
a raising and lowering mechanism configured to raise and lower the gripping device, the raising and lowering mechanism including a gearing mechanism configured to wind and/or unwind at least one tether;
a motor configured to actuate the gearing mechanism to wind and/or unwind the at least one tether, wherein the gearing mechanism includes:
a lifting pulley configured to pull the at least one tether up and/or lower the at least one tether down; and
a winding pulley for spooling and/or unspooling the at least one tether;
wherein the at least one tether extends from the winding pulley to the lifting pulley before extending and connecting to the gripping device.

22. A container lifting assembly according to claim 21, wherein the gearing mechanism comprises:
at least a pair of lifting pulleys connected by a drive shaft, the drive shaft being configured to be driven by the motor to rotate the lifting pulleys.

23. A container lifting assembly according to claim 21, wherein the gearing mechanism comprises:
a first pair of lifting pulleys connected by a first drive shaft and a second pair of lifting pulleys connected by a second drive shaft, the first drive shaft being configured to be driven by the motor and the second drive shaft being configured to be driven by a timing belt connecting the second drive shaft to the motor.

24. A container lifting assembly according to claim 21, wherein the lifting assembly comprises:
an actuator between the lifting pulley and the winding pulley, the actuator being configured to pinch the at least one tether and remove the tension in the tether.

25. A container lifting assembly according to claim 22, wherein the winding pulley is connected to the drive shaft by a timing belt such that the winding pulley is configured to rotate at the same speed as the lifting pulley.

26. A container lifting assembly according to claim 21, wherein the winding pulley comprises:
a spring loaded spooling mechanism configured to bias the winding pulley towards the winding direction.

27. A container lifting assembly according to claim 21, wherein the winding pulley comprises:
a spring and an outer ring, the tether being configured to spool on the outer ring and wherein the spring is configured to bias the outer ring so as to take up any slack in the tether.

28. A container lifting assembly according to claim 21, wherein the lifting pulley is a capstan pulley.

29. A container lifting assembly according to claim 21, wherein the gearing mechanism comprises:
a connecting pulley, the at least one tether being configured to wrap under the connecting pulley before wrapping over the lifting pulley and extending to connect to the gripping device.

30. A container lifting assembly according to claim 21, wherein the tether comprises:
a tape.

31. A container lifting assembly according to claim 30, wherein the tether comprises:
a woven polyester tape.

32. A container lifting assembly according to claim 21, wherein the tether comprises:
a ball chain tether.

33. A container lifting assembly for raising and/or lowering containers stacked in stacks in a grid storage structure, the container lifting assembly comprising:
a gripping device configured to releasably grip a container;
a raising and lowering mechanism configured to raise and lower the gripping device the raising and lowering mechanism including a gearing mechanism configured to wind and/or unwind at least one tether;
a motor configured to actuate the gearing mechanism to wind and/or unwind the at least one tether the gearing mechanism, including:
a lifting pulley configured to pull the at least one tether up and/or lower the at least one tether down, wherein the lifting assembly includes:
a collecting holder for collecting the at least one tether being wound to lift the gripping device.

34. A container lifting assembly according to claim 33, wherein the lifting pulley comprises:
a slip clutch.

35. A container lifting assembly according to claim 21 in combination with a load handling device for lifting and moving containers stacked in stacks in a grid storage structure which includes a plurality of tracks arranged as a grid in a grid pattern above the stacks of containers, the load handling device comprising:
a body housing a driving mechanism operatively arranged for moving the load handling device on the grid; and
wherein the container lifting assembly is configured to raise and lower the gripping device relative to the body and for raising and lowering containers stacked in stacks.

36. A load handling device according to claim 35, wherein the lifting assembly is located within the body of the load handling device.

37. A load handling device according to claim 35, wherein the container lifting assembly is located within an upper portion of the body of the load handling device.

38. A method of raising and/or lowering a container from a stack of containers with container lifting assembly and a load handling device, the container lifting assembly including:
a gripping device configured to releasably grip a container;
a raising and lowering mechanism configured to raise and lower the gripping device the raising and lowering mechanism including a gearing mechanism configured to wind and/or unwind at least one tether;
a motor configured to actuate the gearing mechanism to wind and/or unwind the at least one tether, wherein the gearing mechanism includes:
a lifting pulley configured to pull the at least one tether up and/or lower the at least one tether down; and
a winding pulley for spooling and/or unspooling the at least one tether;
wherein the at least one tether extends from the winding pulley to the lifting pulley before extending and connecting to the gripping device; and
wherein the load handling device includes a body housing a driving mechanism operatively arranged for moving the load handling device on the grid; and
wherein the container lifting assembly is configured to raise and lower the gripping device relative to the body and for raising and lowering containers stacked in stacks; the method comprising:
actuating the gearing mechanism so as to unwind the at least one tether and lower the gripping device relative to the body;
actuating the gripping device to grip a container; and
actuating the gearing mechanism so as to wind the tethers and raise the gripping device relative to the body.

39. A method according to claim 38, comprising the step of:
raising the gripping device relative to the body and lifting the container into a cavity of the load handling device.

40. A container lifting assembly and a load handling device according to claim 35 in combination with a system, the system comprising:
a storage structure accommodating containers stacked in stacks, the storage structure including a first set of tracks extending in a first direction and a second set of tracks extending in a second direction transverse to the first direction, the load-handling device being configured to move on the first and second sets of tracks; and
a control utility configured to control the load handling device to lift a container from a stack beneath the grid and/or lower a container into the grid.
